(19) United States
(12) Patent Application Publication
(10) Pub. No.: US 2009/0049579 A1
(43) Pub. Date: Feb. 26, 2009

(54) Camouflage patterned fabrics made from knitted flame-resistant yarns

(75) Inventor: Jeffrey K. Roberts, Ashland, OR (US)

Correspondence Address: KLARQUIST SPARKMAN, LLP, 121 SW SALMON STREET, SUITE 1600, PORTLAND, OR, 97204, US

(73) Assignee: Massif Mountain Gear Company, L.L.C.

(21) Appl. No.: 12/148,476

(22) Filed: Apr. 18, 2008

Related U.S. Application Data
(60) Provisional application No. 60/926,279, filed on Apr. 25, 2007.

(51) Int. Cl. A62B 17/00; D03D 15/00; D04B 11/20

(52) U.S. Cl. 2/81; 442/301; 2/69; 66/82 R

(57) ABSTRACT

A flame-resistant, camouflage knit fabric is disclosed. The fabric can include a first yarn having a first color, and a second yarn having a second color different than the first color. The fabric may optionally include a third yarn having a third color and/or an elastomeric yarn. These yarns can be knitted together to form a flame-resistant fabric having a multi-colored camouflage pattern. A method for making a flame-resistant, camouflage fabric also is disclosed. The method can include providing a first yarn having a first color and a second yarn having a second color different than the first color and knitting the first and second yarns to form a multi-colored camouflage pattern. The yarns can be knitted using a computer-controlled machine, such as a jacquard knitting machine.

### CROSS REFERENCE TO RELATED APPLICATION

This application claims the benefit of U.S. Provisional Patent Application No. 60/926,279, filed Apr. 25, 2007, which is hereby incorporated by reference.

### FIELD

This application concerns flame-resistant fabrics, such as fabrics made from knitted flame-resistant fibers or fabrics chemically treated to retard flame.

### BACKGROUND

Military personnel operating in environments characterized by a high risk of fire and extreme heat, such as helicopter air crews and tank personnel, typically are required to wear flame-resistant, camouflage clothing. Due to performance limitations of conventional flame-resistant, camouflage fabrics, however, military personnel often forgo the use of flame-resistant clothing in favor of non-flame-resistant clothing. As a result, the personnel can be exposed to an unnecessarily high risk of burn injury.

The fabrics used to make conventional flame-resistant, camouflage clothing primarily include woven fabrics made from flame resistant fibers such as NOMEX® meta-aramid fiber. Woven NOMEX® and other conventional, flame-resistant fabrics typically supply adequate protection from flame and heat hazards, but are not well suited for keeping personnel comfortable, particularly in very cold and very hot environments. These fabrics typically do not stretch or breathe adequately in hot weather or when the wearer is engaged in vigorous physical activity, and do not insulate adequately when the wearer is in winter or alpine environments.

Some knit fabrics made from flame-resistant fibers are stretchable and breathable. Fabrics for military and other applications, however, often require camouflage patterning. It is difficult to dye or print patterns onto knit fabrics made from flame-resistant fibers. Fabrics made from knit fibers are inherently unstable and stretch and contract during processing. This can disrupt the dyed or printed pattern making it impossible to achieve the precision and detail associated with camouflage patterns. In addition, flame-resistant fibers typically do not accept dyes and pigments easily. Furthermore, many dying and printing chemicals are themselves flammable and would jeopardize the flame-resistant properties of the finished fabric.

### SUMMARY

Disclosed herein are embodiments of a fabric, such as a flame-resistant, camouflage knit fabric. Some embodiments of the disclosed fabric include a first yarn having a first color, a second yarn having a second color different than the first color, and an elastomeric yarn. One example of an elastomeric yarn is a spandex yarn. These yarns are understood to be comprised of fibers. Fibers comprise any slender, elongated threadlike structure or object, and can be knitted together to form a multi-colored camouflage pattern (including, e.g., a digital camouflage pattern or other camouflage pattern). The fabric can have a variety of yarn configurations, such as a jacquard knit, a jersey knit, an interlock knit, a simplex knit or a rib knit.

The first and second colored yarns can include a variety of materials, such as polyamide (e.g., aromatic polyamide), polyester, polybenzimidazole, polyvinyl alcohol, polytetrafluoroethylene, wool, polyvinyl chloride, polyetheretherketone, polyetherimide, polyethersulfone, polychlal, polyimide, polyimide-amide, polyolefin, polybenzoxazole, acetone, modacrylic, acrylic, melamine, glass, meta aramids, para aramids, flame-resistant cottons, flame resistant cellulosics, and combinations thereof. As used herein, flame-resistant fabrics and fibers refer to both those fabrics and fibers made from inherently flame-resistant materials and also materials that are treated to retard flame either before or after being knitted together.

In another implementation, the fabric comprises a first yarn of a first color, a second yarn of a second color, a third yarn of a third color and a fourth elastomeric yarn.

Also disclosed are articles of clothing (e.g., shirts, pants, jackets, hats, socks, gloves, etc.) made from the disclosed fabric. In these articles of clothing and in other embodiments of the disclosed fabric, a knit, flame-resistant, camouflage layer can be combined with an additional layer or layers. In some embodiments, a second layer includes a thermo-mechanically expanded fabric. For example, the knit, flame-resistant, camouflage layer can be an outer layer and the second layer can be an inner layer intended to increase the fabric's resistance to wind or moisture.

Also disclosed are embodiments of a method for making a fabric, such as a flame-resistant, camouflage fabric. Some embodiments of the disclosed method include providing a first yarn having a first color and a second yarn having a second color different than the first color. According to these embodiments, the first and second yarns can be knitted to form a multi-colored camouflage pattern. The first and second yarns can be knitted alone or in combination with an elastomeric yarn. The yarns can be knitted, for example, using a computer-controlled machine. In some embodiments, the yarns are knitted using a jacquard machine.

### BRIEF DESCRIPTION OF THE DRAWING

FIG. 1 is a perspective view of a jacket made with an embodiment of the disclosed flame-resistant, camouflage fabric.

FIG. 2 is a magnified view of a portion of the fabric of the jacket in FIG. 1 showing the arrangement of the individual yarns.

### DETAILED DESCRIPTION

Throughout this disclosure, the singular terms “a,” “an,” and “the” include plural referents unless the context clearly indicates otherwise. Similarly, the word “or” is intended to include “and” unless the context clearly indicates otherwise.

Disclosed herein are embodiments of a flame-resistant, camouflage fabric, embodiments of clothing made from the disclosed fabric and embodiments of a method for making the disclosed fabric.

One recognized industry standard for labeling protective clothing as heat and flame resistant is ASTM D6413:F2302-03. Another industry standard is the related ASTM standard requiring no melting and no dripping of flame resistant fabric subjected to test conditions. Flame-resistant fabrics and materials according to the present disclosure can meet these and other standards, such as the NFPA 1977-2005 and NFPA Vertical Flame standards.

The disclosed flame resistant fabric can include yarns of different single colors that are knitted together to form a camouflage pattern, such as a digital or other type of camouflage pattern. Since the pattern is knitted into the fabric, there is no need for printing or dyeing after assembly. Other embodiments using at least one yarn having multiple colors may also be possible.

A variety of fibers can be used in embodiments of the disclosed flame resistant fabric. The fibers can be inherently flame-resistant or modified to enhance flame resistance. For example, some suitable flame-resistant fibers are non-flame-resistant fibers that have been chemically treated to enhance flame resistance. Examples of suitable fibers include polyamide fibers (e.g., aromatic polyamide fibers), polybenzimidazole fibers, polyvinyl alcohol fibers, polytetrafluoroethylene fibers, wool fibers, polyvinyl chloride fibers, polyetheretherketone fibers, polyetherimide fibers, polyethersulfone fibers, polychlal fibers, polyimide fibers, polyimide-amide fibers, polyolefin fibers, polybenzoxazole fibers, acetone fibers, modacrylic fibers, acrylic fibers, melamine fibers, glass fibers, meta aramid fibers, para aramid fibers, and combinations thereof. Examples of fibers that can be treated to become suitable flame-resistant fibers include polyester fibers, nylon fibers, cellulose fibers (e.g., cotton fibers and rayon fibers), and combinations thereof.

The colored yarns can be knitted with elastomeric yarns. Examples of elastomeric yarns suitable for use in embodiments of the disclosed fabric include spandex yarns, such as LYCRA® yarns. The addition of elastomeric yarns generally makes the fabrics more stretchable and comfortable for the wearer. Conventionally, incorporating elastomeric yarns into flame-resistant, camouflage fabrics was not possible. The printing and dyeing processes conventionally used to apply camouflage patterns to flame-resistant fabrics typically require the use of harsh chemicals (e.g., solvents, dye diffusion promoters, carriers and swelling agents) and/or high temperatures, which would destroy delicate elastomeric yarns. The relative amount of elastomeric yarn compared to the other colored yarns can vary depending on the application or particular fabric desired. Different embodiments may comprise from just greater than 0% by weight elastomeric yarns to nearly 100% by weight elastomeric yarns. In some embodiments comprising colored yarns that have been treated to increase flame resistance, elastomeric yarns may be present in an amount from about greater than 0% by weight up to about 20% by weight. In some embodiments comprising colored yarns that are inherently flame-resistant, elastomeric yarns may be present in an amount from about greater than 0% by weight up to about 4% by weight.

Rather than dyeing or printing after being knitted into a fabric, the yarns in embodiments of the disclosed fabric can be colored prior to being knitted into a fabric. For example, the yarns can be producer-colored, stock-dyed, solution-dyed, package-dyed, continuous-dyed, skein-dyed, and/or piece-dyed prior to being knitted into a fabric. Examples of methods for coloring flame-resistant fibers and yarns can be found in U.S. Pat. Nos. 5,275,627 and 6,867,154, which are incorporated herein by reference.

According to one specific embodiment, two yarns of different colors (e.g., one brown yarn and one green yarn) are knitted into a camouflage patterned fabric. According to another embodiment, three yarns of different colors (e.g., one brown yarn, one green yarn and one tan yarn) are knitted into a camouflage patterned fabric. Additional embodiments may comprise four or more yarns of four or more different colors. Alternative implementations can include any number of yarns, where some yarns may be of the same color and/or some yarns may be of different colors. Of course, as described above, one or more elastomeric yarns can be included together with the colored yarns. The elastomeric yarns can be of the same color as one or more of the colored yarns, or may be of a different color.

The yarns in embodiments of the disclosed fabric can be assembled using a variety of techniques. In some embodiments, assembly by knitting is preferred. For example, the yarns can be assembled in a jacquard knit. Alternatively, the yarns can be assembled in a jersey knit (e.g., a single jersey knit or a double jersey knit), an interlock knit, a simplex knit or a rib knit. The resulting fabric can be, for example, a fleece fabric, such as a single-sided or double-sided fleece fabric. Suitable examples of the resulting fabric can include double-sided 13 oz. fleece fabric, and single-sided 10 oz. fleece fabric. Using embodiments of the disclosed method, it is possible to form complex patterns, including digital camouflage patterns.

The yarns can be knitted using a computer-controlled knitting machine. One example of a suitable computer-controlled knitting machine is the RELANIT® 1.6e machine available from Mayer & Cie. GmbH & Co. KG (Germany). Computer-controlled knitting machines typically include a fixed bed of hooked needles. During operation, a carriage box passes across the needles to produce each row of stitches. The carriage box can cause the needles to move or not move according to the computer instructions, typically resulting in a slip stitch or a tuck stitch. The needles can be arranged in a flat or circular configuration. The RELANIT® 1.6e machine, for example, is a circular knitting machine.

Embodiments of the disclosed fabric can include multiple layers. In some embodiments, the camouflage pattern is knitted into an outer layer and the fabric includes one, two, three, four, or more additional layers. Additional layers useful with the camouflage layer include layers that enhance wind and/or water resistance, layers that enhance comfort, breathability, wicking, and/or rapid drying, and layers that increase warmth or insulation provided by the fabric. In some embodiments a camouflage patterned outer layer is combined with another layer to enhance the wind and/or water resistance of the overall fabric. For example, the camouflage patterned outer layer can be combined with a layer of thermo-mechanically expanded fabric, such as a hydrophobic polyurethane or microporous PTFE barrier membrane.

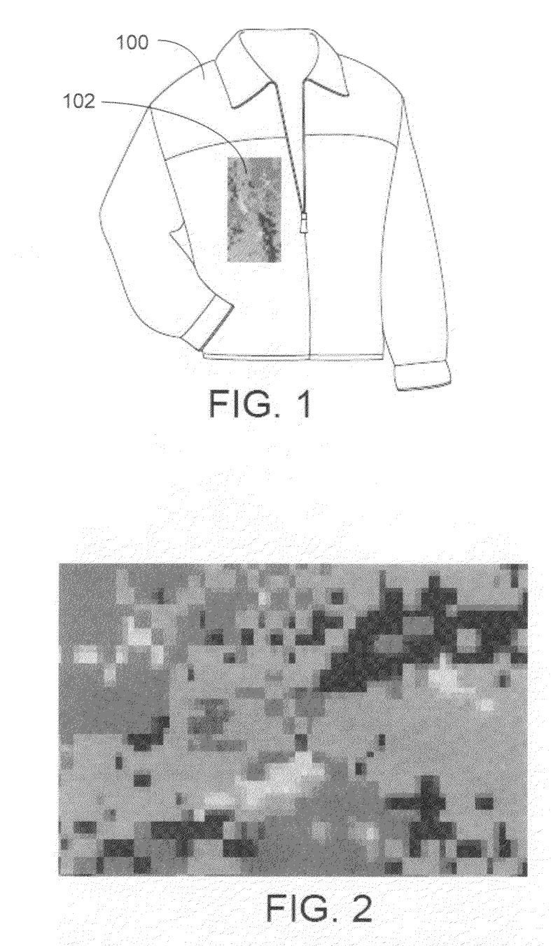

The disclosed fabric can be incorporated into a variety of items. FIG. 1 shows a jacket 100 made with an embodiment of the disclosed fabric. The jacket 100 includes a digital camouflage pattern 102. FIG. 2 is a magnified view of a portion of the fabric of the jacket 100 in FIG. 1, showing the arrangement of the individual yarns. In the jacket 100, the yarns are arranged in a jersey knit. As discussed above, the yarns also can be arranged in a variety of other knitted forms. Conventional sewing techniques can be used to convert embodiments of the disclosed fabric into articles of clothing, such as the jacket 100. The disclosed fabric also can be used, for example, in socks, pants, shirts, gloves, hats, etc., and in non-clothing items, such as blankets, covers, tents, blinds, backpacks, shoes, etc. Multiple different fabrics according to the present disclosure may be combined to form a single garment or non-clothing item. Additionally, flame-resistant fabrics according to the present disclosure may be used with conventional fabrics to form a garment or non-clothing item.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

1. A flame-resistant fabric, comprising
a first flame-resistant yarn having a first color; and
a second flame-resistant yarn having a second color different than the first color, wherein at least the first and second flame-resistant yarns are knitted together to form a multi-colored camouflage pattern.

2. The fabric according to claim 1, wherein the first and second yarns are knitted together with an elastomeric yarn to form the multi-colored camouflage pattern.

3. The fabric according to claim 2, wherein the elastomeric yarn is a spandex yarn.

4. The fabric according to claim 2, wherein the elastomeric yarn is present in an amount from about 0% to about 20% by weight.

5. The fabric according to claim 2, wherein the elastomeric yarn is present in an amount from about 0% to about 4% by weight.

6. The fabric according to claim 1, wherein the first flame-resistant yarn, the second flame-resistant yarn or both are comprised of polyamide, aromatic polyamide, polyester, polybenzimidazole, polyvinyl alcohol, polytetrafluoroethylene, wool, polyvinyl chloride, polyetheretherketone, polyetherimide, polyethersulfone, polychlal, polyimide, polyimide-amide, polyolefin, polybenzoxazole, acetone, modacrylic, acrylic, melamine, glass, meta aramid, para aramid, cotton, cellulose, nylon, or combinations thereof.

7. The fabric according to claim 1, wherein the fabric is treated with a flame-retardant chemical to enhance resistance to flame.

8. The fabric according to claim 1, wherein the camouflage pattern is a digital camouflage pattern.

9. The fabric according to claim 1, wherein the fabric is a fleece fabric.

10. The fabric according to claim 1, wherein the fabric is a jacquard-knit fabric.

11. The fabric according to claim 1, wherein the fabric is a jersey-knit fabric, an interlock-knit fabric, a simplex-knit fabric or a rib-knit fabric.

12. The fabric according to claim 1, wherein the first and second yarns are within an outer layer and the fabric further comprises a second layer comprising a thermo-mechanically expanded fabric.

13. The fabric according to claim 1, further comprising a third flame-resistant yarn having a third color different from the first and the second colors, wherein at least the third yarn is knitted together with the first and second flame-resistant yarns to form the multi-colored camouflage pattern.

14. The fabric according to claim 13 wherein the fabric is a fleece fabric.

15. The fabric according to claim 13, wherein the first, second and third flame-resistant yarns are knitted together with an elastomeric yarn to form the multi-colored camouflage pattern.

16. The fabric according to claim 15 wherein the fabric is a fleece fabric.

17. An article of clothing, incorporating a flame resistant fabric comprised of:
a first flame-resistant yarn having a first color;
a second flame-resistant yarn having a second color different than the first color, wherein at least the first and second yarns are knitted together to form a multi-colored camouflage pattern.

18. The article of clothing according to claim 17, wherein the article of clothing is a shirt, jacket, pullover, hat, or pant.

19. The article of clothing according to claim 17, wherein the camouflage pattern is a digital camouflage pattern.

20. The article of clothing according to claim 17, further comprising a third flame-resistant yarn having a third color different than the first and second color and an elastomeric yarn, wherein at least the third flame-resistant yarn and the elastomeric yarn are knitted together with the first and second flame-resistant yarn to form the multi-colored camouflage pattern.

21. The article of clothing according to claim 17, wherein the first and second flame-resistant yarns are within an outer layer and the fabric further comprises a second layer.

22. The article of clothing according to claim 21 wherein the second layer comprises a thermo-mechanically expanded fabric.

23. A method for making a flame-resistant fabric, comprising:
providing a first yarn having a first color and a second yarn having a second color different than the first color; and
knitting the first and second yarns to form a flame-resistant fabric having a multi-colored camouflage pattern.

24. The method according to claim 23, wherein knitting the first and second yarns comprises knitting the first and second yarns with a computer-controlled knitting machine.

25. The method according to claim 23, wherein knitting the first and second yarns comprises knitting the first and second yarns with a jacquard knitting machine.

26. The method according to claim 23, further comprising providing an elastomeric yarn, wherein knitting the first and second yarns comprises knitting the first and second yarns with the elastomeric yarn to form the multi-colored camouflage pattern.

27. The method according to claim 26, wherein the elastomeric yarn is a spandex yarn.
